(19) United States
(12) Patent Application Publication
(10) Pub. No.: US 2008/0189840 A1
(43) Pub. Date: Aug. 14, 2008

(54) Thermal liner

(76) Inventors: Warren Francis Knoff, Richmond, VA (US); Richard Hall Young, Richmond, VA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/704,481

(22) Filed: Feb. 9, 2007

(51) Int. Cl. A62B 17/00; D02G 3/00

(52) U.S. Cl. 2/458; 428/365

(57) ABSTRACT

The present invention concerns thermal liner comprising crimped, heat resistant fibers held in a state of compression by a thermoplastic binder, wherein when the thermal liner is exposed to heat or flame, the liner increases its thickness by at least three times. The invention also relates to use of such barriers in protective fabrics, garments, and articles.

### FIELD OF THE INVENTION

The invention concerns thermal liners having good thermal insulation and breathability under non-emergency conditions but when under high thermal exposure having a dramatic increase in thermal insulation, thereby providing excellent thermal protection.

### BACKGROUND OF THE INVENTION

The thermal liners used in firefighter's turnout coats have two thermal property needs that are in opposition to each other. During non-emergency conditions, the thermal liner should have good thermal insulation and breathability to provide maximum comfort for the wearer. However, in the event of a high thermal exposure such as encountered in an emergency condition, the thermal liner must have high thermal insulation in order to protect the wearer from burns. Turnout coats which provide high levels of thermal insulation are typically bulky during all conditions. The bulk of these coats inhibits the ability of the user to perform due to movement inhibition and fatigue related to the weight. Thus, there is a need to provide adequate protection with reduced bulk during non-emergency conditions.

### SUMMARY OF THE INVENTION

In another embodiment, the invention concerns a composite fabric system, comprising:

an outer shell fabric;

a moisture barrier; and

a thermal liner; the thermal liner comprising at least one thermally expanding flame resistant fabric made from crimped, heat resistant fibers held in a state of compression by a thermoplastic binder, wherein when the thermally expanding flame resistant fabric is exposed to heat or flame, the fabric increases its thickness by at least three times.

In some embodiments, the thermal liner further comprises at least one non-expanding flame resistant fabric which, when exposed to heat or flame, does not increase its thickness by at least three times. In certain embodiments, the fabrics are mechanically attached. Methods of mechanically attaching the fabrics include, but are not limited to, stitching and quilting.

Some flame resistant fabric includes an open mesh scrim having the compressed fibers on at least one side.

In some embodiments, the composite fabric system is a component of a protective garment.

The invention also relates to a method of protecting an object from heat comprising interposing between the object and the source of heat a thermal barrier comprising crimped, heat resistant fibers held in a state of compression by a thermoplastic binder. In some embodiments, the object is a human and the thermal barrier resides in protective apparel.

### DETAILED DESCRIPTION OF ILLUSTRATIVE EMBODIMENTS

In some aspects, the invention relates to thermal liners comprising crimped, heat resistant fibers held in a state of compression by a thermoplastic binder. These liners, when exposed to heat or flame, increase in thickness by at least three times the barriers pre-exposure thickness. In some embodiments, these barriers comprise a thermally activating nonwoven thin sheet that when exposed to heat increase it's thickness at least three times (3×) and, in some embodiment, up to ten times (10×) by means of a bulking mechanism. Under normal conditions, the thermal barrier has good thermal conductivity and breathability, whereas under high thermal exposure, the barrier's thermal conductivity decreases dramatically thus, providing excellent protection.

In some embodiments of the invention, the thermal liners can be used in protective garments having at least three layers or constructions, each layer or fabric construction performing a distinct function. There is an outer shell fabric that provides flame protection and serves as a primary defense from flames for the fire fighter. Adjacent to the outer shell is a moisture barrier that is typically a liquid barrier but can be selected such that it allows moisture vapor to pass through the barrier. Adjacent to the moisture barrier is a thermal liner described herein. The moisture barrier keeps the thermal liner dry and thermal liner insulates the wearer from heat during firefighting activities. Heat stress can be a byproduct of wearing heavy garment and doing hard work.

In some embodiments, the thermal liner further comprises at least one non-expanding flame resistant fabric which, when exposed to heat or flame, does not increase its thickness by at least three times. In some embodiments, the non-expanding fabric is positioned on the far side of the thermal liner from the moisture barrier. In a garment, this layer could be positioned between the wearer and the thermal layer.

In some embodiments, more than one thermal expanding nonwoven can be used in the composite fabric system or garment. The thermal barriers can be in contact with each other or separated by one or more substantially non-expanding fabric. In some preferred embodiments, the non-expanding fabric is flame-resistant.

The term “adjacent to,” when used to refer to layers, does not necessarily mean that one layer is immediately next to another layer. An intervening layer may occur between adjacent layers. Layers that directly contact each other, however, are still adjacent to each other.

The thermoplastic binder can be in the form of fiber or powder and should be used in an amount sufficient to hold crimped fiber in compressed state. Any type of binder that will hold the heat resistant fibers in compression can be utilized. In some embodiments, useful binders include crimped sheath-core bonding fiber having a core of semi-crystalline polyethylene terephthalate surrounded by a sheath of an adhesive polymer formed from isophthalate and terephthalate esters. The sheath is heat softenable at a temperature lower than the core material. Such fibers are available from Unitika Corp. of Osaka, Japan. Other sheath/core adhesive fibers, however, may be used with the present invention. Other binders include copolyesters and polyamides. In addition, one can contact the heat resistant fibers with a liquid adhesive to achieve thermal barrier. Examples of such adhesives include aqueous dispersions of adhesives.

The term “shell fabric” is used to denote the outer layer of an article (such as a garment) that provides primary flame protection. The shell can consist of any flame resistant fabric. In some embodiments, the shell comprises aramid fiber. One suitable aramid is poly(metaphenylene isophthalamide) which is marketed under the tradename of Nomex® by E.I. DuPont de Nemours, Inc. Other fabrics utilize poly(paraphenylene terephthalamide) (marketed under the tradename of Kevlar® by E.I. DuPont de Nemours, Inc.) or polyarenazole (PBI, for example). Fabrics containing more then one of the aforementioned fibers may also be utilized (Nomex®/Kevlar® or Kevlar®/PBI, for example).

The “moisture barrier” is a component that serves as a liquid barrier but can allow moisture vapor to past through the barrier. In articles such as firefighter turn out coasts, these barriers keep water away from the firefighter and thereby minimizes the weight which the firefighter carries. In addition, the barrier allows water vapor (sweat) to escape—an important function when working in a hot environment. Typically, the moisture barrier component comprises a membrane laminated to a nonwoven or woven fabric. Membrane materials used to laminate to the fabric include polytetrafluoroethylene (PTFE) and polyurethane. Examples of such laminates include Crosstech® PTFE membrane or Neoprene® membranes on a fibrous nonwoven or woven meta-aramid fabric.

The term “fabric” is intended to mean a planar textile structure produced by interlacing yarns, fibers, or filaments.

A “scrim” is a lightweight, open, coarse fabric

By “non-woven” fabric is meant a network of fibers, including unidirectional (if contained within a matrix resin), felt, fiber batts, and the like.

By “woven” fabric is meant a fabric woven using any fabric weave, such as plain weave, crowfoot weave, basket weave, satin weave, twill weave, and the like. Plain and twill weaves are believed to be the most common weaves used in the trade.

“Crimped fibers” are preferably staple fibers that have cut lengths in the range of 0.4 to 2.5 inches (1 to 6.3 cm) preferably 0.75 to 2 inches (1.9 to 5.1 cm) and preferably have 2 to 5 crimps per centimeter (5 to 12 crimps per inch). Such fibers can be formed by stretch breaking continuous fibers resulting in staple fibers with deformed sections that act as crimps. The staple fibers can also be cut from continuous fibers having a saw tooth shaped crimp along the length of the staple fiber.

The phrase “heat resistant” when used in conjunction with fibers includes those fibers, including staple fibers, which are useful in the reinforced nonwoven fire-blocking fabric of this invention. The heat resistant fibers include aramids and polyarenazoles. These fibers include fiber made from para-aramid, polybenzazole, polybenzimidazole, and polyimide polymer. In some embodiments, the preferred heat resistant fiber is made from aramid polymer. In certain of these embodiments, para-aramid polymer is preferred.

As used herein, “aramid” refers to a polyamide wherein at least 85% of the amide (—CONH—) linkages are attached directly to two aromatic rings. “Para-aramid” means the two rings or radicals are para oriented with respect to each other along the molecular chain. Additives can be used with the aramid. In fact, it has been found that up to as much as 10 percent, by weight, of other polymeric material: can be blended with the aramid or that copolymers can be used having as much as 10 percent of other diamine substituted for the diamine of the aramid or as much as 10 percent of other diacid chloride substituted for the diacid chloride of the aramid. In the practice of this invention, the preferred para-aramid is poly(paraphenylene terephthalamide). Methods for making para-aramid fibers useful in this invention are generally disclosed in, for example, U.S. Pat. Nos. 3,869,430, 3,869,429, and 3,767,756. Such aromatic polyamide organic fibers and various forms of these fibers are available from DuPont Company, Wilmington, Del. under the trademark Kevlar®.

The thermal expanding nonwoven can be compressed by any means known in the art. As used herein, the term “compressed” when referring to fibrous webs from one or more cards and optionally an open mesh scrim can be collected on a transporting belt. Preferably the scrim is inserted between two webs to make a two web structure, although a single web structure can be made by overlaying a scrim over a single web or a single web over the scrim. Additional webs can be laid on either of the one or two web structures if needed.

In one embodiment, the final structure has two carded webs on one side of the open mesh scrim and one carded web on the other side of the scrim. In another embodiment, each side of the optional scrim has a fibrous web adjacent thereto.

Binder powder can then be applied to the combined webs and scrim in a preferred amount of about 3.4 to 24 g/m² (0.1 to 0.7 oz/yd²). The combined webs, binder powder, and scrim are then conveyed through an oven at a temperature sufficient to soften and partially melt the binder fiber and powder and allow it to adhere the fibers together. At the oven exit the sheet is preferably compressed between two steel rolls to consolidate the layers into a cohesive fabric. The fabric is then cooled in this compressed state.

In some embodiments, no binder powder is utilized and the binder consists only of fibrous binder.

The term thickness refers to value obtained from a standard pedestal mounted micrometer.

The phrase “flame resistant” refers to a fabric that has a char length less than 4 inch per vertical flame test ASTM 1640.

The invention is illustrated by the following examples which are not intended to be limiting.

### Test Methods

Thermal Protection Performance (TPP). Thermal protection performance was determined using test method described in NFPA 1971 Standard on Protective Ensemble for Structural Fire Fighting 200 Edition, Section 6-10. Fabric Failure Factor (FFF) values are also reported. This value is the TPP value normalized to the basis weight of the fabric.

Vertical Flame Test. Vertical flame performance of the reinforced nonwoven fabric was measured using ASTM D6413-99

Thickness. Thickness measurement of the reinforced fabric of this invention were measured using ASTM D1777-96 Option 1.

Basis Weight. Basis weight was determined from the weight of the 6.75″×6.75″ TPP test specimens.

### EXAMPLE 1

A reinforced nonwoven fabric was prepared as follows. 70 parts by weight 2.2 denier per filament (dpf), 2″ cut length Type 970 Kevlar® brand staple fiber and 30 parts 4 dpf, 2″ (50 mm) cut length Type 4080 Unitika 50/50 sheath/core 110° C. melting point binder fiber were blended as fed from bales to three cards. Fiber webs from the three cards were collected on a transporting belt to create a fiber mat having a basis weight of approximately 2.7 oz/yd². An open mesh scrim of polyester filament yarn was inserted between the two webs formed by the first two cards. The open mesh scrim was a Saint Gobain 5×10 scrim (Type KPMR10510/P3 having 5 ends/inch of 150 denier polyester in the fill direction and 10 ends/inch of 70 denier polyester in the warp direction) and had a basis weight of 0.3 oz/yd². The resulting structure had two carded webs on one side of the open mesh scrim and one carded web on the other side of the scrim.

The combined webs and scrim were conveyed through an oven at 141° C. to melt the binder fiber. At the oven exit the sheet was compressed between two steel rolls with 0″ gap at a pressure of about 100 pounds force/linear inch, which consolidated the components into a cohesive fabric. The fabric then cooled in this compressed state.

The final composition of the fabric was approximately 63% Kevlar® fiber, 27% binder fiber, 10% polyester scrim. Characterization data of this nonwoven is included in Table 1.

### EXAMPLE 2

The compressed reinforced nonwoven fabric of example 1 above was layered with the following additional components in the order given: 7.5 osy (ounces/yard²) Kevlar®/PBI (60/40 blend of KEVLAR® T970 and PBI fiber formed into a two end rip stop fabric having 56×51 ends per inch with 9 ends provided between each pair of ripstop yarns in the warp direction and 7 picks provided between each end in the filling direction), Crosstech®/NOMEX® PJ moisture barrier (comprising of a PTFE film with a polyurethane layer attached to a 3.3 osy NOMEX® IIIA two end rip stop fabric having 68×68 ends per inch with 4 ends between each pair of ripstop yarns in warp and filling directions). The nonwoven of Example 1 is inserted between DuPont 1.5 osy style 715 NOMEX® E-89™ spunlaced aramid and 4.5 osy Nomex® woven fabric (NOMEX® IIIA fiber formed into a plain weave fabric having 66×42 ends per inch). The layers of the thermal liner were quilted together using NOMEX® thread and a square quilt pattern. The performance of this composite is included in Table 2.

### EXAMPLE 3

A reinforced nonwoven fabric was prepared as follows. 70 parts by weight 2.2 dpf, 2″ cut length Type 970 Kevlar® brand staple fiber and 30 parts 4 dpf, 2″ (50 mm) cut length Type 4080 Unitika 50/50 sheath/core 180° C. melting point binder fiber were blended as fed from bales to three cards. Fiber webs from the three cards were collected on a transporting belt to create a fiber mat having a basis weight of approximately 2.7 oz/yd². An open mesh scrim of polyester filament yarn was inserted between the two webs formed by the first two cards. The open mesh scrim was a Saint Gobain 5×10 scrim (Type KPMR10510/P3 having 5 ends/inch of 150 denier polyester in the fill direction and 10 ends/inch of 70 denier polyester in the warp direction) and had a basis weight of 0.3 oz/yd². The resulting structure had two carded webs on one side of the open mesh scrim and one carded web on the other side of the scrim.

The combined webs and scrim were conveyed through an oven at 191° C. to melt the binder fiber. At the oven exit the sheet was compressed between two steel rolls with 0″ gap at a pressure of about 100 pounds force/linear inch, which consolidated the components into a cohesive fabric. The fabric then cooled in this compressed state.

The final composition of the fabric was approximately 63% Kevlar® fiber, 27% binder fiber, 10% polyester scrim. Characterization data of this nonwoven is included in Table 1.

### EXAMPLE 4

The compressed reinforced nonwoven fabric above was layered with the following additional components in the order given: 7.5 osy Kevlar®/PBI (60/40 blend of KEVLAR® T970 and PBI fiber formed into a two end rip stop fabric having 56×51 ends per inch with 9 ends provided between each pair of ripstop yarns in the warp direction and 7 picks provided between each end in the filling direction), Crosstech/PJ moisture barrier (comprising of a PTFE film with a polyurethane layer attached to a 3.3 osy NOMEX® IIIA two end rip stop fabric having 68×68 ends per inch with 4 ends between each pair of ripstop yarns in warp and filling). The nonwoven of Example 3 was inserted between DuPont 1.5 osy style 715 NOMEX® E-89™ spunlaced aramid, 4.5 osy Nomex® woven fabric (NOMEX® IIIA fiber formed into a plain weave fabric having 66×42 ends per inch). The layers of the thermal liner were quilted together using NOMEX® thread and a square quilt pattern. The performance of this composite is included in Table 2.

### EXAMPLE 5 (COMPARATIVE)

The following fabrics were layered in the order given: 7.5 osy Kevlar®/PBI (60/40 blend of KEVLAR® T970 and PBI fiber formed into a two end rip stop fabric having 56×51 ends per inch with 9 ends provided between each pair of ripstop yarns in the warp direction and 7 picks provided between each end in the filling direction), Crosstech/PJ moisture barrier (comprising of a PTFE film with a polyurethane layer attached to a 3.3 osy NOMEX® IIIA two end rip stop fabric having 68×68 ends per inch with 4 ends between each pair of ripstop yarns in warp and filling), two layers of DuPont 1.5 osy style 715 NOMEX® E-89™ spunlaced aramid, 4.5 osy Nomex® woven fabric (NOMEX® IIIA fiber formed into a plain weave fabric having 66×42 ends per inch). The layers of the thermal liner were quilted together using NOMEX® thread and a square quilt pattern. The performance of this composite is included in Table 2.

### EXAMPLE 6 (COMPARATIVE)

The following fabrics were layered in the order given: 7.5 osy Kevlar®/PBI (60/40 blend of KEVLAR® T970 and PBI fiber formed into a two end rip stop fabric having 56×51 ends per inch with 9 ends provided between each pair of ripstop yarns in the warp direction and 7 picks provided between each end in the filling direction), Crosstech/PJ moisture barrier (comprising of a PTFE film with a polyurethane layer attached to a 3.3 osy NOMEX® IIIA two end rip stop fabric having 68×68 ends per inch with 4 ends between each pair of ripstop yarns in warp and filling), DuPont 2.3 osy style 723 NOMEX® E-89™ spunlaced aramid, DuPont 1.5 osy style 715 NOMEX® E-89™ spunlaced aramid, 4.5 osy Nomex® woven fabric (NOMEX® IIIA fiber formed into a plain weave fabric having 66×42 ends per inch). The layers of the thermal liner were quilted together using NOMEX® thread and a square quilt pattern. The performance of this composite is included in Table 2.

TABLE 1

| | Example | |
|---|---|---|
| | 1 | 3 |
| Binder Fiber Melitng Point, ° C. | 110 | 180 |
| Scrim Type | Bayex 5 × 10 | Bayex 5 × 10 |
| Basis Weight, oz/yd² | 3.2 | 3.5 |
| Thickness, mils | | |
| As Received | 30 | 31 |
| After 5 minutes @ 500° F. | 215 | 133 |
| Vertical Flame (ASTM 6413) | | |
| After flame, sec (warp/fill) | 0/2.47 | 0/0 |
| Afterglow, sec (warp/fill) | 0.65/0.53 | 0.75/0.7 |
| Char, inches (warp/fill) | 0.5/0.175 | 0.5/0.15 |

TABLE 2

Example

| | 2 | 4 | 5 | 6 |
|---|---|---|---|---|
| Composite Description | | | | |
| Outer shell layer | Kevlar ®/PBI woven | Kevlar ®/PBI woven | Kevlar ®/PBI woven | Kevlar ®/PBI woven |
| Moisture barrier layer | Crosstech PJ | Crosstech PJ | Crosstech PJ | Crosstech PJ |
| Thermal barrier | | | | |
| Layer 1 of thermal barrier | 1.5 osy E-89 | 1.5 osy E-89 | 1.5 osy E-89 | 2.3 osy E-89 |
| Layer 2 or thermal barrier | Example 1 (Table 1) | Example 3 (Table 1) | 1.5 osy E-89 | 1.5 osy E-89 |
| Layer 3 of thermal barrier | 4.5 osy Nomex ® | 4.5 osy Nomex ® | 4.5 osy Nomex ® | 4.5 osy Nomex ® |
| | woven | woven | woven | woven |
| Composite Performance | | | | |
| As Received | | | | |
| NFPA 1971 section 6-10 | | | | |
| TPP, cal/cm² | 40.7 | 38.7 | 32.9 | 35.3 |
| time, sec | 20.2 | 19.2 | 16.3 | 17.5 |
| FFF, cal/cm²/oz/yd² | 1.9 | 1.7 | 1.6 | 1.7 |
| Basis Weight, oz/yd² | 21.9 | 22.2 | 20.5 | 21.3 |
| Thickness, mils | 105 | 104 | 87 | 98 |
| Pre Heated (5 min @ 500 deg F.) | | | | |
| NFPA 1971 section 6-10 | | | | |
| TPP, cal/cm² | 55.5 | 48.5 | 33.7 | 36.2 |
| time, sec | 27.5 | 24.1 | 16.7 | 18 |
| FFF, cal/cm²/oz/yd² | 2.5 | 2.2 | 1.6 | 1.7 |
| Basis Weight, oz/yd² | 22.3 | 22.2 | 20.5 | 21.2 |
| Thickness, mils | 549 | 485 | 88.67 | 97.34 |
| % TPP Improve | 36% | 25% | 2.4% | 2.5% |
| % Thickness Improve | 522% | 466% | 2% | 0% |

While the present invention may be understood more readily by reference to the detailed description of illustrative and preferred embodiments that form a part of this disclosure, it is to be understood that the scope of the claims is not limited to the specific devices, methods, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

What is claimed:

1. A composite fabric system having a thermal barrier comprising:
an outer shell fabric;
a moisture barrier; and
a thermal liner; said thermal liner comprising at least one thermally expanding flame resistant fabric made from crimped, heat resistant fibers held in a state of compression by a thermoplastic binder, wherein when the thermal liner is exposed to heat or flame, the liner increases its thickness by at least three times.

2. The composite fabric system of claim 1, wherein the thermal liner further comprises at least one non-expanding flame resistant fabric which, when exposed to heat or flame, does not increase its thickness by at least three times.

3. The composite fabric system of claim 2 wherein the fabrics are mechanically attached.

4. The composite fabric system of claim 1, wherein at least one flame resistant fabric includes an open mesh scrim having the compressed fibers on at least one side.

5. The composite fabric system of claim 1, wherein the heat resistant fibers comprise para-aramid fiber.

6. The composite fabric system of claim 5, wherein the para-aramid fiber comprises poly(paraphenylene terephthalamide).

7. The composite fabric system of claim 1, wherein the thermoplastic binder comprises fiber or powder.

8. The composite fabric system of claim 1, wherein the thermoplastic binder comprises copolyester.

9. A protective garment having a thermal liner comprising:
an outer shell fabric;
a moisture barrier; and
a thermal liner; said thermal liner comprising at least one thermally expanding flame resistant fabric made from crimped, heat resistant fibers held in a state of compression by a thermoplastic binder, wherein when the thermal liner is exposed to heat or flame, the liner increases its thickness by at least three times.

10. The protective garment of claim 9, wherein the thermal liner further comprises at least one non-expanding flame resistant fabric which, when exposed to heat or flame, does not increase its thickness by at least three times.

11. The protective garment of claim 10 wherein the fabrics are mechanically attached.

12. The protective garment of claim 9, wherein at least one flame resistant fabric includes an open mesh scrim having the compressed fibers on at least one side.

13. The protective garment of claim 9, wherein the heat resistant fibers comprise para-aramid fiber.

14. The protective garment of claim 13, wherein the para-aramid fiber comprises poly(paraphenylene terephthalamide).

15. The protective garment of claim 9, wherein the thermoplastic binder comprises fiber or powder.

16. The protective garment of claim 9, wherein the thermoplastic binder comprises copolyester.

17. The protective garment of claim 9, wherein the shell fabric comprises (poly(m-phenylene isophthalamide)).

18. A method for protecting a person from heat comprising interposing between the object and the source of heat a composite fabric comprising:
an outer shell fabric;
a moisture barrier; and
a thermal liner; said thermal liner comprising at least one thermally expanding flame resistant fabric made from crimped, heat resistant fibers held in a state of compression by a thermoplastic binder, wherein when the thermal liner is exposed to heat or flame, the liner increases its thickness by at least three times.

19. The method of claim 18, wherein the thermal liner further comprises at least one non-expanding flame resistant fabric which, when exposed to heat or flame, does not increase its thickness by at least three times.

20. The method of claim 19 wherein the fabrics are mechanically attached.
